(19) United States
(12) Patent Application Publication
(10) Pub. No.: US 2010/0092231 A1
(43) Pub. Date: Apr. 15, 2010

(54) Shower Nozzle having a Brush

(76) Inventor: Shen-Mu KAO, Bade City (TW)

Correspondence Address: HDLS IPR Services, PO Box 220746, Chantilly, VA, 20153, US

(21) Appl. No.: 12/573,867

(22) Filed: Oct. 5, 2009

(30) Foreign Application Priority Data
Oct. 9, 2008 (CN) 200810148897.7

(51) Int. Cl. A46B 11/00

(52) U.S. Cl. 401/268

(57) ABSTRACT

A shower nozzle having a brush for bathing includes a shower nozzle body and a brush head which is driven by a power member disposed in the shower nozzle body. The power member is supplied power by an internal battery or an external power supply. Thereby, when the user takes a bath, the combination of the shower nozzle and the brush is able to supply water for cleaning and has a brushing function, enhancing the cleaning effect.

### BACKGROUND OF THE INVENTION

1. Field of the Invention

The present invention relates to a cleaning device for a human body, and more particularly to a shower nozzle providing brushing and washing functions.

2. Description of the Prior Art

In general, a shower nozzle is used to supply water for taking a bath. First, the user sprinkles water on his/her body and applies soap or shower cream to the body. Finally, he/she washes the body. Some people use a brush to scrub his/her body when taking a bath. It is inconvenient to take a brush and a shower nozzle as well as soap or beauty products at one time.

Accordingly, the inventor of the present invention has devoted himself based on his many years of practical experiences to solve this problem.

### SUMMARY OF THE INVENTION

The primary object of the present invention is to provide a shower nozzle having a brush for bathing, which includes a shower nozzle body and a brush head which is driven by a power member disposed in the shower nozzle body. The power member is supplied power by a battery. Thereby, when the user takes a bath, the combination of the shower nozzle and the brush is able to supply water for cleaning and has a brushing function. The present invention cleans skin pores and skin and removes cutin efficiently.

In order to achieve the aforesaid object, the present invention comprises a main body, a power member, and a brush head. The bottom of the main body is formed with a connecting part for connecting with a water tube for water supply. The main body is provided with a battery and the power member therein. The battery supplies power to start the power member. The power member has an output shaft. The front of the output shaft is coupled to the brush head which is driven by the power member. The brush head has at least one aperture for spraying water. The battery is rechargeable. The brush head can be replaced for hygiene.

### BRIEF DESCRIPTION OF THE DRAWINGS

FIG. 1 is an exploded view of the present invention;

FIG. 2 is a perspective view of the present invention;

FIG. 3 is a cross-sectional view of the present invention when in use;

FIG. 4 is a perspective view of the present invention when in use;

FIG. 5 is a schematic view showing a brush head of the present invention to be separated;

FIG. 6 is a schematic view showing the present invention to be filled in shower cream;

FIG. 7 is a schematic view showing the present invention to be charged; and

FIG. 8 is a perspective view showing the present invention to be charged.

### DETAILED DESCRIPTION OF THE PREFERRED EMBODIMENTS

Embodiments of the present invention will now be described, by way of example only, with reference to the accompanying drawings.

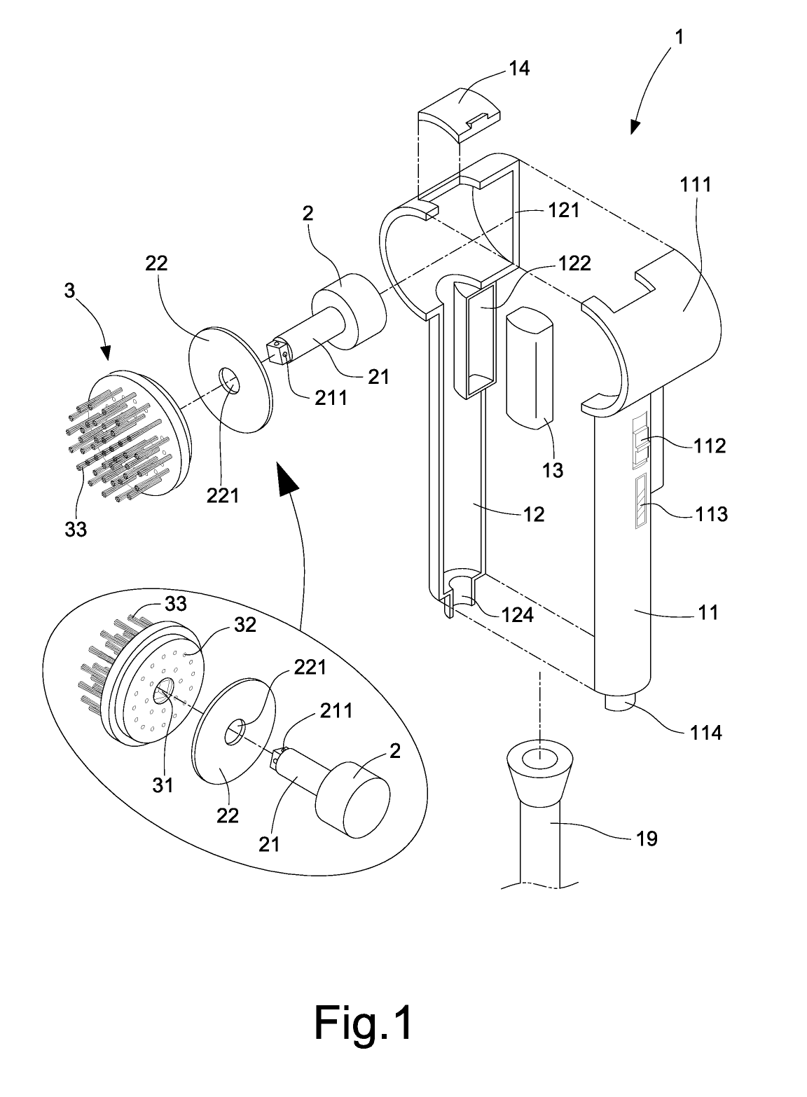

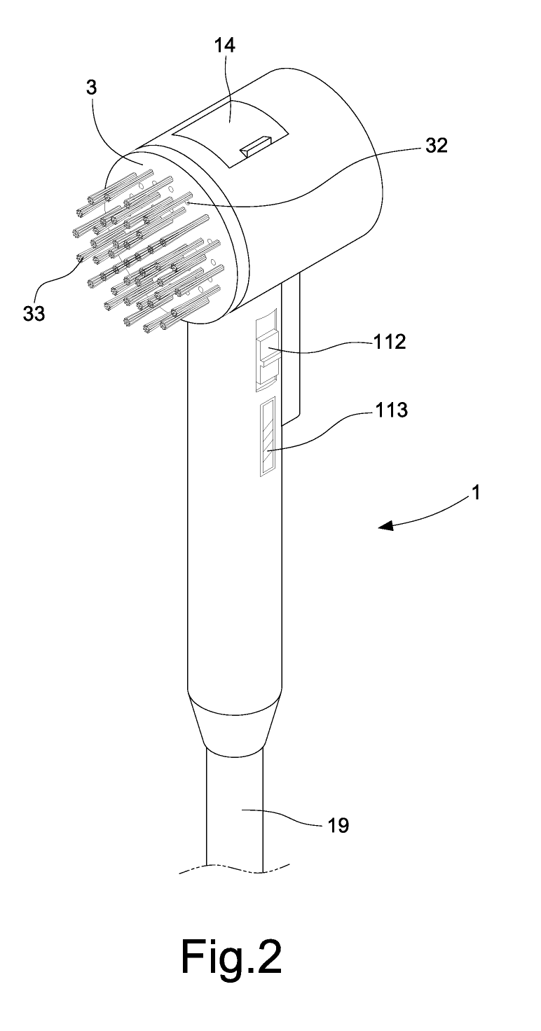

As shown in FIGS. 1 and 2, a shower nozzle having a brush according to a preferred embodiment of the present invention comprises a main body 1, a power member 2, and a brush head 3.

The main body 1 is composed of a first housing 11 and a second housing 12. The first housing 11 includes an upper lid 111, a switch 112, a display 113, and a connecting part 114. The second housing 12 includes an upper lid 121, a battery trough 122, and a connecting part 124. The connecting parts 114,124 are adapted to connect with a water tube 19 for water supply. The main body 1 is provided with a movable cover 14 thereon. The battery trough 122 is adapted to receive a battery 13 therein. The display 113 is used to show the power condition.

The power member 2 can be a motor, which is disposed between the upper lids 111, 121 and connected with the battery 13 to get power for rotation. The power member 2 is provided with a waterproof plate 22 and other parts for waterproofing. The power member 2 includes an output shaft 21 extending through a through hole 221 of the waterproof plate 22.

The brush head 3 has a shaft hole 31 for engaging with the output shaft 21, at least one aperture 32 thereon, and bristles 33 on a front surface thereof.

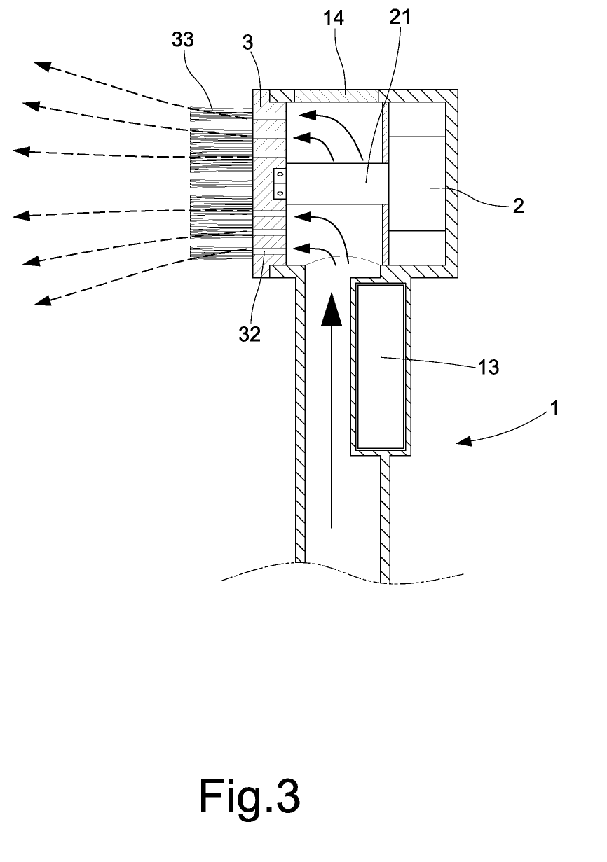

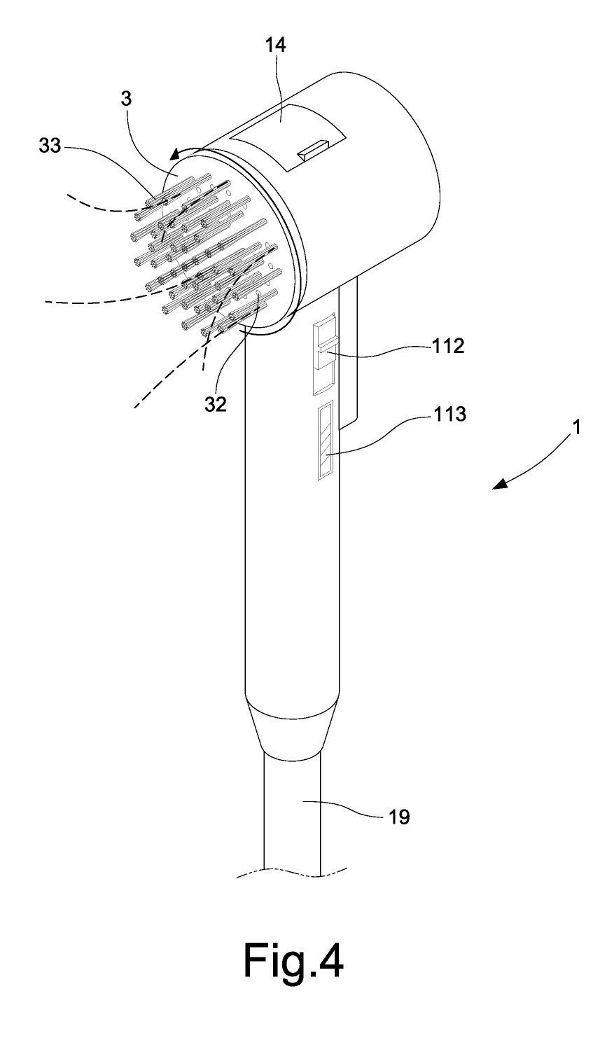

As shown in FIGS. 2 and 3, water enters the main body 1 through the water tube 19 into the chamber between the first and second housings 11, 12 and the upper lids 111, 121, and flows out from the aperture 32 of the brush head 3 for the user to take a shower. When the switch 112 is turned on to start the power member 2, the shat 21 will be turned to drive the brush head 3, as shown in FIG. 4. The bristles 33 contact the skin of the user for cleaning skin pores and skin and removing cutin. The water flows out from the aperture 32 while the brush head 3 is rotated so as to facilitate bathing.

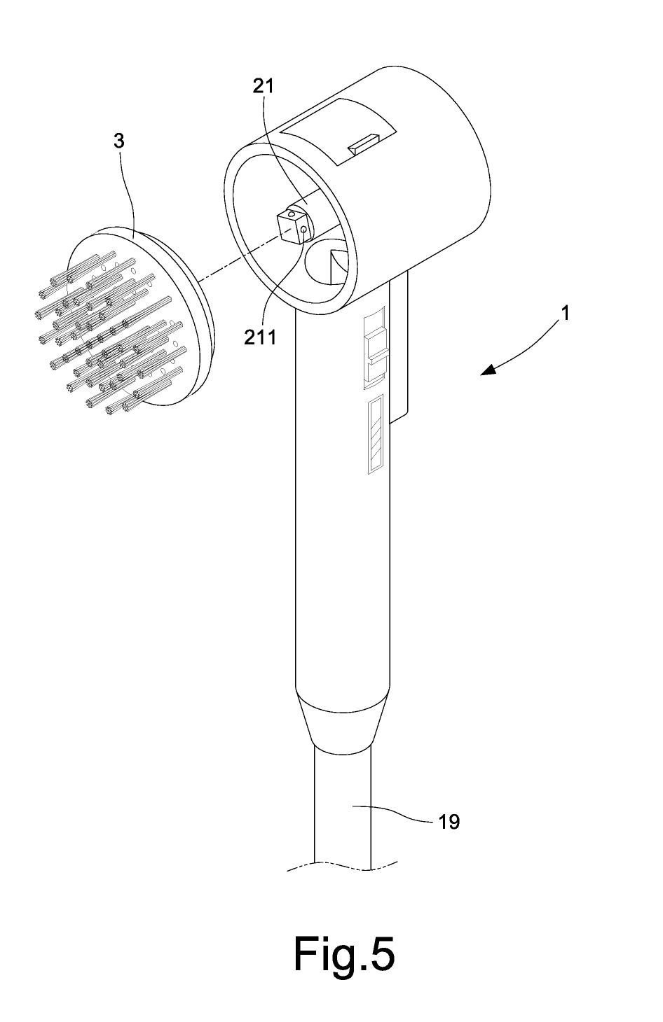

As shown in FIG. 5, the brush head 3 is adapted to engage with an engaging member 211 provided on the output shaft 21 so that the brush head 3 can be replaced for hygiene.

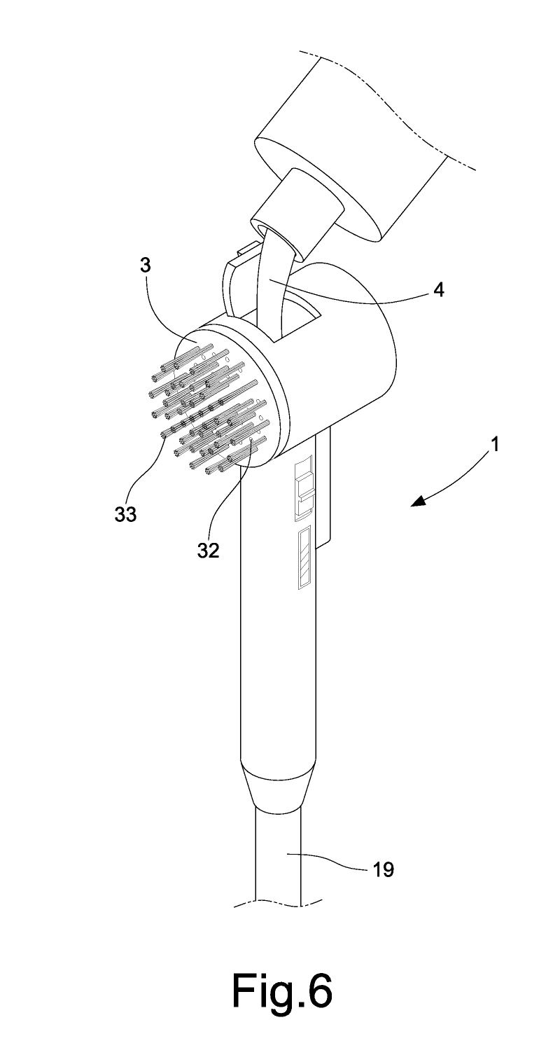

As shown in FIG. 6, the main body 1 of the present invention is provided with the movable cover 14 for filling in shower cream 4 or beauty products to mix with the water in the main body 1 and flow out from the aperture 32.

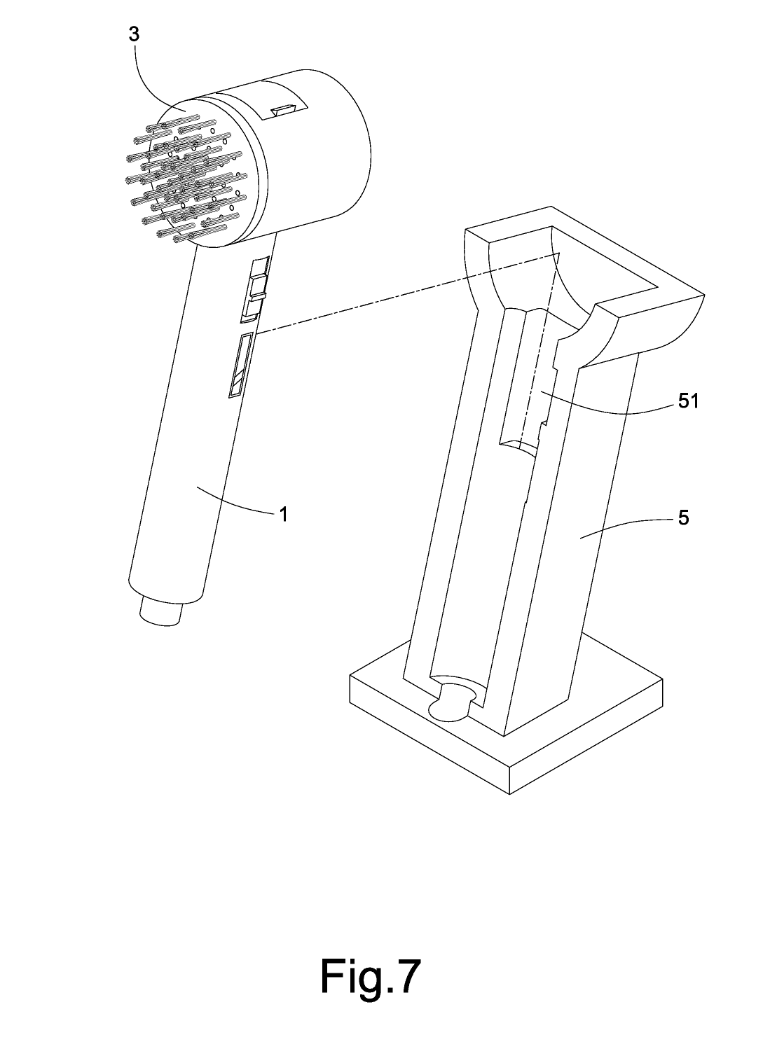

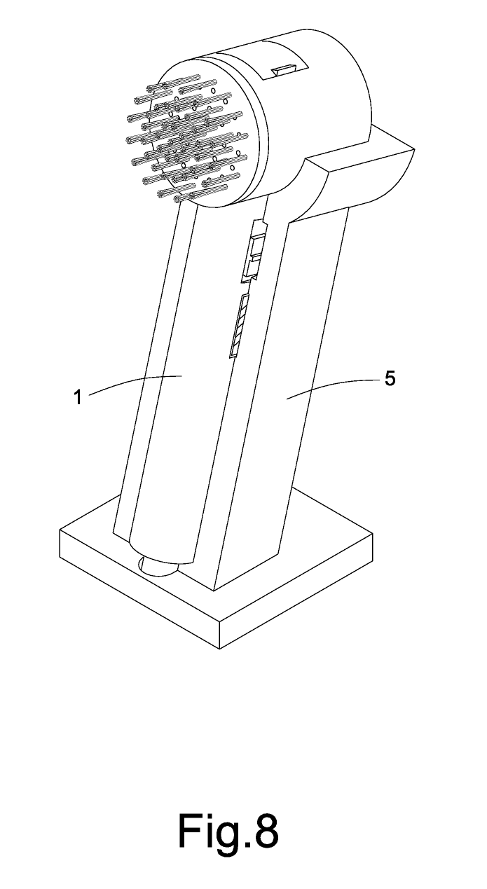

The battery 13 is rechargeable, which is incorporated with a charging seat 5, as shown in FIG. 7. Referring to FIGS. 1, 7, 8, the main body 1 and the water tube 19 are separable. The main body 1 is placed on the charging seat 5. The charging seat 5 is formed with an inductive charging area 51 for the battery 13 to charge. The charging technique may adopt point charging or inductive charging, which is not the feature of the present invention and won't be described hereinafter.

The present invention can be provided with a sensing member at a desired place. When the main body 1 approaches a human body, the sensing member is able to detect automatically for starting the power member 2 to drive the brush head in a predetermined period of time, providing an automatic starting and timing effect.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A shower nozzle having a brush, comprising:
a main body connected with a water tube to supply water;
a power member disposed in the body, the power member including an output shaft; and
a brush head coupled to the main body and connected with the output shaft of the power member, the brush head having at least one aperture and bristles on a front surface thereof.

2. The shower nozzle having a brush as claimed in claim 1, wherein the main body is provided with a battery therein, the battery being connected with the power member for supplying power.

3. The shower nozzle having a brush as claimed in claim 1, wherein the main body is composed of two housings.

4. The shower nozzle having a brush as claimed in claim 1, wherein the main body is provided with a switch thereon.

5. The shower nozzle having a brush as claimed in claim 1, wherein the main body is provided with a display thereon.

6. The shower nozzle having a brush as claimed in claim 2, wherein the main body is formed with a battery trough for receiving the battery therein.

7. The shower nozzle having a brush as claimed in claim 1, wherein the main body has a connecting part for connecting with the water tube.

8. The shower nozzle having a brush as claimed in claim 1, wherein the output shaft is provided with an engaging member for engaging with the brush head.

9. The shower nozzle having a brush as claimed in claim 1, wherein the main body is provided with a movable cover thereon.

10. The shower nozzle having a brush as claimed in claim 1, wherein the battery in the main body is incorporated to a charging seat for charging.

11. The shower nozzle having a brush as claimed in claim 1, wherein the power member is provided with a waterproof structure disposed in the main body.

12. The shower nozzle having a brush as claimed in claim 1, further comprising a sensing member for automatically starting when approaching a human body.
